(19) United States
(12) Patent Application Publication
(10) Pub. No.: US 2006/0143082 A1
(43) Pub. Date: Jun. 29, 2006

(54) Advertisement system and method

(76) Inventor: Peter Ebert, Menlo Park, CA (US)

Correspondence Address: PETER EBERT, 2180 Camino De Los Robles, MENLO PARK, CA, 94025, US

(21) Appl. No.: 11/317,367

(22) Filed: Dec. 23, 2005

Related U.S. Application Data
(60) Provisional application No. 60/638,805, filed on Dec. 24, 2004.

(51) Int. Cl. G06Q 30/00

(52) U.S. Cl. 705/14

(57) ABSTRACT

A system and method allowing customers to create and place advertisements on advertisement presentation nodes via a communication network.

### BACKGROUND

1. Field of the Invention

This description relates to a system and method that allows creating, distributing, and managing advertisements via a communication network.

2. Background of the Invention

A multitude of conventional channels exist that allow customers to present advertisement content to audiences. These channels include radio, television, print media, and the Internet. However, most of these channels require significant lead times for placing advertisement content. These significant lead times typically prevent customers who need to execute time-critical or ad hoc advertisement strategies from using the heretofore-mentioned channels, for example, if such customers need to advertise last minute hotel room vacancies.

While the above-mentioned problem can in principle be solved by using Internet advertisement, for example in the form of banner ads or e-mail ads, a number of challenges remain. For example, only audiences that have access to Internet sites or services that present the placed advertisements can be reached this way. In addition, offers that typically require the physical presence of a buyer, such as last-minute theater tickets, last minute hotel room vacancies, or ad hoc dining specials, are not well suited to be advertised using conventional Internet channels, as interested Internet users may be located far away and thus unable to take advantage of an advertised offer.

### SUMMARY

The present invention introduces a system and method allowing one or more users of the invented system and method to place advertisement content on a multitude of advertisement presentation nodes via one or more communication networks, and more particularly, to enable the placement of advertisement content in a rapid, self-service fashion. The term user of the invented system shall refer to a human being or any software that is suited to communicate or interact with the invented system.

The present invention introduces a multitude of commercially valuable features and services. For example, one embodiment of the present invention is to allow users of an advertisement service to rapidly setup and deploy advertisement collections via a communication network.

Another embodiment of the present invention is to allow users of an advertisement service to monitor and analyze the effectiveness of an advertisement collection via the advertisement service.

Another embodiment of the present invention is to bill customers of the advertisement service at least partly according to log data that is recorded by advertisement presentation nodes upon presenting an ordered advertisement for these customers to a specific target audience.

Another embodiment of the present invention is to allow advertisement presentation nodes to act as profit centers that can accept and present advertisements according to business rules. In this case, for example, advertisement presentation nodes may enter in a franchise business relationship with a specific advertisement service or advertisement presentation node network.

Additional objects and advantages of the present invention will become apparent to those skilled in the art based on the following drawings and detailed description.

### DRAWINGS

FIG. 1A depicts an implementation of an advertisement service, which is connected via a communication network to a customer interface, a service interface, three advertisement presentation nodes, and an advertisement presentation node network.

FIG. 1B is a block diagram of an advertisement service connected with several external services.

FIG. 2 is a block diagram of an advertisement.

FIG. 3 is a block diagram of an advertisement collection.

FIG. 4 is an example of an XML representation of an advertisement.

FIG. 5 is an example of an XML representation of an advertisement collection.

FIG. 6 is an example of an XML representation of an advertisement designed for being presented in multiple steps to audiences traveling along a specific route.

FIG. 7A depicts a typical implementation of the invention.

FIG. 7B depicts an alternative implementation of the invention.

FIG. 8 is a flowchart illustrating an example of how an advertisement presentation node may interact with an advertisement service.

FIG. 9 is a flowchart illustrating an example of how a customer of an advertisement service may use the advertisement service.

FIG. 10 is a flowchart illustrating an example of how an advertisement presentation node may detect, and react to, a specific class of audience.

FIG. 11 depicts an implementation of two advertisement services, an advertisement service broker, three advertisement presentation nodes, and an advertisement presentation node network.

### DETAILED DESCRIPTION

In the following, a system according to the present invention shall be referred to as an advertisement service. An advertisement service can be connected to one or more advertisement presentation nodes via one or more communication networks such as the Internet, an intranet, or wireless networks, for example.

An advertisement presentation node is a device capable of controlling the presentation of at least one advertisement (defined below). In addition, an advertisement presentation node may be able to detect whether an audience (defined below) for the controlled presentation of an advertisement is present. If no such audience is present, the advertisement presentation node may be instructed not to present the advertisement.

An advertisement presentation node may also be able to determine a class of an audience that attends the presentation that the advertisement presentation node controls. The class of an audience may be inferred by the type of vehicle that an audience is driving in, the type of one or more wireless communication devices an audience is carrying, or any other means available to the advertisement presentation node operable to automatically determine a class of an audience.

The present invention particularly supports advertisement presentation nodes in the spirit of U.S. patent application Ser. No. 10/077,741 entitled “Method And Apparatus For Adding Commercial Value To Traffic Control Systems”, filed Feb. 14, 2002.

An audience consists of one or more human beings. Different types of audiences may, for example, be distinguished by their anticipated potential interest and ability to buy a specific class of product. For example, an audience driving in a vehicle of type Porsche may be more likely to buy a Rolex watch than an audience driving in a vehicle of type Chevrolet. An advertisement presentation node may also be able to detect the gender of an audience, for example by applying digital image recognition to digital images taken of an audience.

Types of communication devices carried by an audience may, for example, be detected by scanning for short-range communication signals coming from communication devices located in close vicinity of the audience, the signals containing identifiers or other information suited to identify or infer the type or model of the detected communication device. An example for a short-range communication technology supporting the above-described detection of specific communication devices is Bluetooth, a digital two-way radio technology that allows devices to form personal area networks. If a specific communication device type or model carried by an audience has been detected by an advertisement presentation node, a typical market value of the detected communication device may be determined and related to a specific class of audience. The typical market value may, for example, be retrieved from a local database containing communication device type—market value data. Alternatively, for example, the typical market value of a detected communication device may be retrieved using a web service providing such data via a communication network.

An audience carrying at least one high value communication device, for example, may be related to a higher income audience class than an audience that merely carries low value communication devices. In addition, an audience that carries at least one model of a communication device that has been released very recently may be related to an early adopter audience class.

An advertisement presentation node may use a combination of audience detection technologies in order to determine the class of an audience attending the presentation of an advertisement controlled by the advertisement presentation node. An advertisement presentation node may then use this classification information to select the edition of an advertisement that is most likely to appeal to the detected audience in the best possible way when presenting the advertisement. To that end, an advertisement presentation node may be able to apply methods, for example statistical methods, suited to determine a predominant class of audience in case heterogeneous or even conflicting data is being received in the process of detecting the class of an audience.

Additionally, or alternatively, an advertisement presentation node may communicate the detected class of an audience attending a specific presentation of an advertisement to the advertisement service that invoked the presentation. The advertisement service may use this audience class data to generate demographic information collections, models, or maps, describing, for example, which classes of audiences are likely to be encountered at which advertisement presentation nodes and at which times.

An advertisement presentation node may control one or more electronic displays. In particular, an advertisement presentation mode may control two or more electronic displays that are placed in specific distances from each other along the same street or route.

Advertisement presentation nodes may belong to one or more advertisement presentation node networks. An advertisement presentation node network may contain, or be affiliated with, a multitude of advertisement presentation nodes that are connected via one or more communication networks, particularly including, but not limited to, a private network, for example.

An advertisement can be understood as an instruction that can be processed by an advertisement presentation node in order to perform a presentation of the advertisement. An advertisement may contain attributes, content, and rules suited to at least partly define what, when, where, to whom, and how specific advertisement content shall be presented.

The term advertisement content shall be referred to as any content that can be presented by at least one advertisement presentation node. Advertisement content may particularly consist of, link to, or include, text, digital images, vector data, animations, 3-dimensional vector data or animations, digital video, or digital audio. Advertisement content may also at least partly consist of one or more announcements, news, or messages. Additionally, advertisement content may consist of, or contain, one or more editions. The term edition shall be referred to as content that is typically either tailored to appeal to a specific target audience, or represent a part of a multi-sequential advertisement. A multi-sequential advertisement is typically designed for presentation by advertisement presentation nodes controlling two or more electronic displays that are placed in specific distances from each other along the same street or route.

An advertisement collection can be understood as an instruction suited to control and orchestrate a multitude of advertisement presentations according to an advertisement strategy. Advertisement collections can contain one or more advertisements, as well as specific attributes and rules. For example, an advertisement collection may be used for defining an advertisement strategy targeting specific audiences at a multitude of locations at various times, involving a multitude of advertisement presentation nodes.

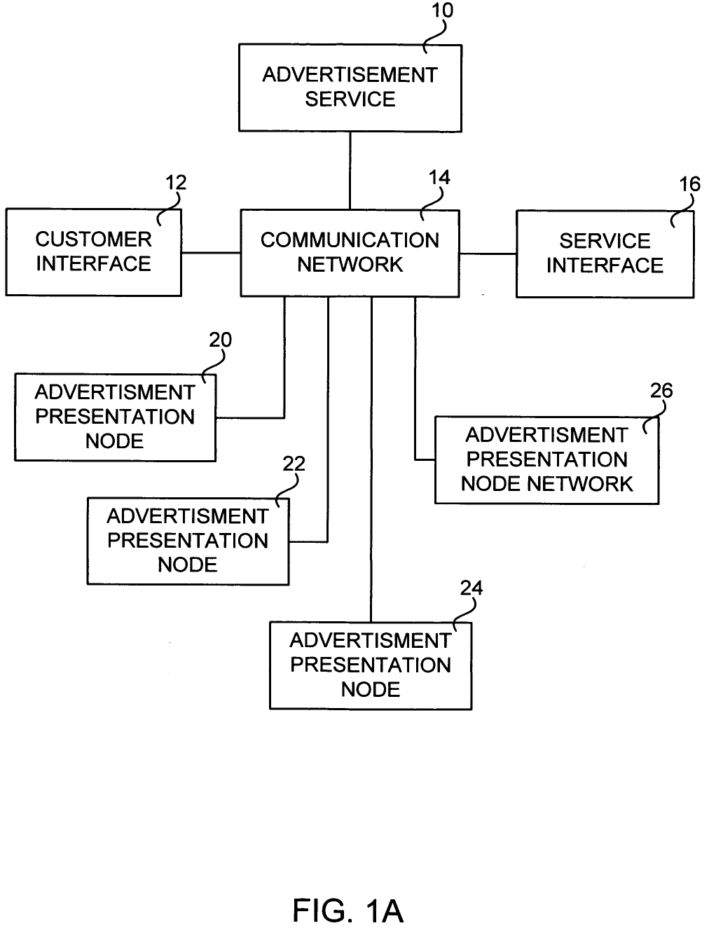

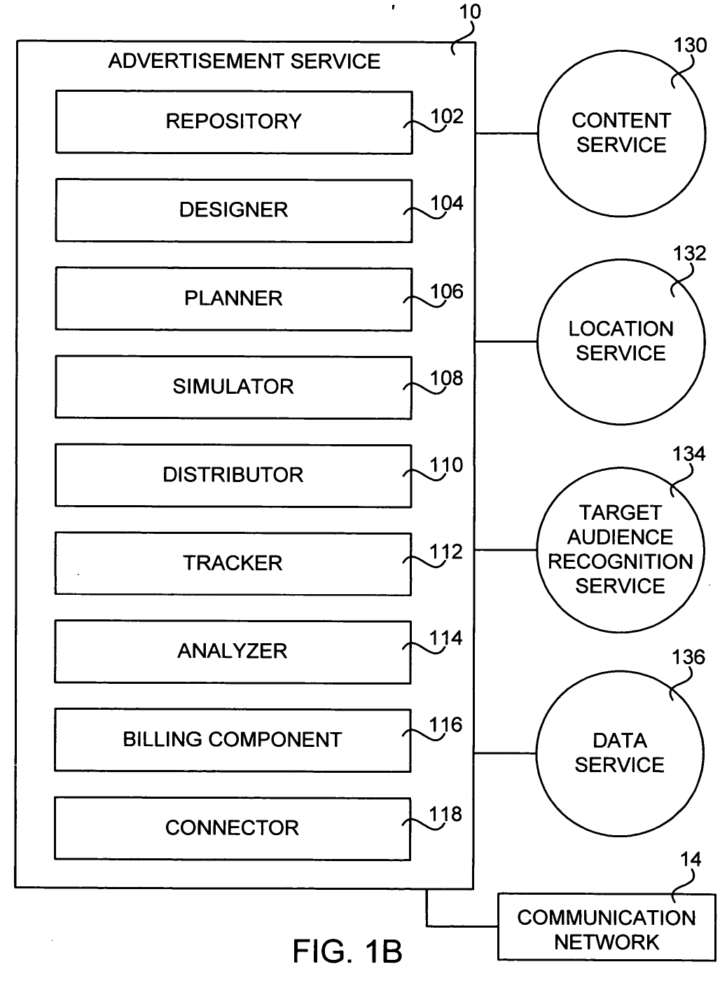

FIG. 1A depicts an implementation of an advertisement service 10, which is connected via communication network 14 to customer interface 12, service interface 16, advertisement presentation nodes 20,22, and 24, and advertisement presentation node network 26.

Communication network 14 may be the Internet, for example. Customer interface 12 allows customers of advertisement system 10 to remotely use services and functions exposed to these customers by advertisement system 10 via communication network 14. As an example, customers may log in to advertisement service 10 via customer interface 12, create a new advertisement collection, and initiate the execution of the new advertisement collection via advertisement presentation nodes 20, 22, and 24. As another example, customers may monitor the performance of a specific advertisement presentation node based on data transmitted by this specific advertisement presentation node to advertisement service 10. As yet another example, customers may search advertisement service 10 for advertisement presentation nodes showing availability for the presentation of advertisements in a specific geographic area and within a specific time frame. As yet another example, customers may pay for rendered services of advertisement service 10 via customer interface 12, for example via an online credit card payment process.

It shall be understood that the number of connected advertisement presentation nodes and advertisement presentation node networks is only meant as an example and not limited to three or four. In fact, it is desirable for a typical implementation of advertisement service 10 to be connected to a large number of advertisement presentation nodes, for example in order to maximize geographic reach, coverage, market share, and revenue.

Service interface 16 allows, for example, business partners, content providers, or other services, to interact with, or use, specific functions of advertisement service 10. For example, advertisement service 10 may expose a registration and data upload service for advertisement content providers via service interface 16. As another example, advertisement service 10 may expose via service interface 16 a maintenance service suited to detect malfunctions of connected advertisement presentation nodes and dispatch maintenance crews accordingly.

Advertisement presentation node network 26 represents an interface or proxy to a multitude of advertisement presentation nodes that are not directly connected to communication network 14, but are connected via a private network like an intranet, or shielded from communication network 14 behind a firewall. Advertisement service 10 is able to communicate with advertisement presentation node network 26 through communication network 14, for example in order to deploy advertisement collections to an independent provider of advertisement presentation nodes represented by advertisement presentation node network 26.

Advertisement presentation nodes may be able to detect whether an audience is present during a presentation of an advertisement, and if so, which class of audience it is. For example, by taking one or more pictures of an audience using a digital camera and applying image recognition to these pictures, an advertisement presentation node may be able to recognize the type of vehicle that an audience is using, while the audience is waiting in front of a red traffic light located near the advertisement presentation node. The recognized type of vehicle may then be used in order to select and present an appropriate edition of an advertisement to the audience waiting inside of the recognized vehicle. For example, the advertisement presentation node may present a different advertisement or edition to an audience inside a family van than an audience inside a sports car.

FIG. 1B is a block diagram illustrating an implementation of advertisement service 10 that is connected with communication network 14 and several external services. It shall be understood that one or more of the shown components or services may not be used or used in a different way, and functionality of some components may be implemented in whole or part by other internal or external components or services.

Advertisement service 10 may include a repository 102, a designer 104, a planner 106, a simulator 108, a distributor 110, a tracker 112, an analyzer 114, a billing component 116, and a connector 118.

If included in advertisement service 10, repository 102 is suited to store and retrieve at least a part of the data that is part of the business processes performed by advertisement service 10. It shall be understood that repository 102 may consist of a multitude of local or distributed data repositories and services suited to provide the heretofore-mentioned data services. For example, repository 102 may contain advertisements, advertisement collections, advertisement content, advertisement templates, advertisement collection templates, planning data, simulation data, customer account data, billing rules, billing data, geographic locations of connected advertisement presentation nodes, geographic feature data like street data or customer locations, demographic data for example allowing to determine the proximity of specific routes or geographic areas to neighborhoods predominantly populated by specific target audiences, as well as data coming from connected advertisement presentation nodes, such as engagement-, performance- or maintenance data, or any combination thereof.

If included in advertisement service 10, designer 104 is suited to allow customers of advertisement service 10 to perform at least a part of the definition of advertisements and advertisement collections, including, for example, creating or importing advertisement content, defining specific advertisement rules, defining specific advertisement attributes, packaging advertisements, and including the packaged advertisements into advertisement collections.

For example, designer 104 may allow a customer to create a new advertisement using a previously defined advertisement template, produce, assemble and add advertisement content consisting of multiple different editions containing digital video content, add rules that specify which editions shall be presented to which audience during what time, and then store the newly created advertisement in repository 102. Alternatively, designer 104 may not contain functionality to produce advertisement content but allow importing and assembling pre-produced advertisement content in order to define advertisements or advertisement collections. Designer 104 may provide customers with one or more software wizards that simplify the definition of advertisements.

If included in advertisement service 10, planner 106 offers functionality suited to identify and book advertisement presentation nodes that are available to present one or more advertisements. Planner 106 may book advertisement presentation nodes either directly one by one, or indirectly by applying an advertisement collection. Planner 106 may be able to optimize the booking of advertisement presentation nodes according to a variety of criteria, for example in order to minimize cost, maximize coverage, avoid competitive advertisement campaigns, exclude low-performing geographical areas, exclude low-performing advertisement presentation nodes, exclude areas with conditions potentially negatively affecting the success of advertisements, the conditions particularly including weather conditions, or prefer the booking of advertisement presentation nodes located at geographical areas populated or visited by desired audience classes.

In addition, planner 106 may be suited to identify available time slots of multiple advertisement presentation nodes that, for example, are located in a specific geographic area or along a specific route, and schedule and book the presentation of advertisements via the identified advertisement presentation nodes accordingly. Planner 106 may perform such scheduling and booking, for example, by automatically generating and distributing specific advertisement collections.

Planner 106 may also contain functionality suited to consult customers of advertisement service 10 where and when to place advertisements in order to optimize the desired effect of the advertisements. Planner 106 may perform such consultation at least partly based on previously recorded target audience behavior. As an example, planner 106 may communicate to a customer which advertisement presentation nodes have been encountering the most sports car drivers during a specific time period, based on data produced by advertisement presentation nodes connected to advertisement service 10, the advertisement presentation nodes able to recognize and communicate encountered target audiences.

Planner 106 may also contain functionality required by a customer of advertisement service 10 for performing and finalizing a booking process, particularly including identity checks, credit checks, and electronic payment processes. Alternatively, at least a part of this functionality may be provided by other internal or external components or services of advertisement service 10, for example by billing component 116.

If included in advertisement service 10, simulator 108 may allow simulating and predicting the effectiveness and cost of presenting specific advertisements or advertisement collections. Such simulations and predictions may, for example, be accomplished based on demographic data and latest known target audience behavior patterns available to simulator 108. This type of simulation may particularly be helpful for customers of advertisement service 10 that plan to be billed based on the number of successfully presented advertisements to desired target audiences, as simulator 108 may enable these customers to plan and apply their available advertisement budgets in a highly targeted fashion. Simulator 108 may include sophisticated visualization features such as multi-layered, semi-transparent digital maps, 3-dimensional graphics, or animated time series visualizations on top of digital maps.

Distributor 110 allows performing and managing the transfer of required data to advertisement presentation nodes defined to present specific advertisements. In particular, distributor 110 may provide functionality suited to distribute large amounts of data in an optimized way so that, for example, involved communication networks are utilized in the most efficient, economic, and timely fashion. This functionality is particularly advantageous when applied to advertisement presentation nodes at least partly connected with advertisement service 10 via low bandwidth communication networks. For example, in order to distribute an advertisement collection that is supposed to be presented nationwide, distributor 110 may first distribute the content required for the presentation to specific main data hubs or advertisement presentation nodes that feature high-bandwidth network connections. In a second step, distributor 110 may then instruct advertisement presentation nodes having lower bandwidth network connections to download required content from one of their closest main data hubs or high-bandwidth advertisement presentation nodes. Alternatively or additionally, distributor 110 may expose a publish-and-subscribe service that advertisement presentation nodes can subscribe to. In this case, upon receiving an advertisement collection, distributor 110 may generate and publish individual messages or group messages to the advertisement presentation nodes specified to present the advertisement collection. These messages may either directly contain the data required to perform the presentation, or instructions on where to download the presentation data from, or any combination thereof.

Distributor 110 may also provide functionality for keeping at least a part of the software and data stored on advertisement presentation nodes up-to-date. For example, distributor 110 may periodically deploy updated data and software suited to enable advertisement presentation nodes to recognize target audience classes. As another example, distributor 110 may be able to deploy software updates or basic input/output system (BIOS) updates to advertisement presentation nodes.

Distributor 110 may also feature functionality that allows determining whether and when a specific advertisement collection has been partly or fully distributed and expose this information to, for example, tracker 112.

If included in advertisement service 10, tracker 112 allows customers to rapidly and remotely monitor the effectiveness of the execution of a specific advertisement or advertisement collection. For example, tracker 112 may be able to provide a visualization containing a digital map showing the latest number of successful target audience engagements of specific advertisement presentation nodes. In another example, tracker 112 may be able to visualize advertisement presentation nodes that show technical problems affecting their ability to present advertisements as planned. In yet another example, tracker 112 may be able to visualize a digital map showing advertisement presentation nodes currently presenting advertisements in the context of a specific advertisement collection, the digital map also visualizing conditions potentially negatively affecting the success of these advertisements, such as bad weather when presenting a sunscreen lotion advertisement, for example.

If included in advertisement service 10, analyzer 114 may allow, for example, to slice and dice and visualize data stored in repository 102 according to specific reporting criteria. For example, analyzer 114 may be able to provide last quarter versus actual quarter key performance indicator reports by customer segment of advertisement service 10.

As another example, analyzer 114 may be able to provide a list of advertisement presentation nodes that had the most encounters with a given target audience class in a specific time frame. As yet another example, analyzer 114 may be able to relate data stored as part of advertisement service 10 with data provided by external data service 136. In this case, for example, analyzer 114 may provide reporting data ranking the effectiveness of advertisement presentations according to related point of sales data. As yet another example, analyzer 114 may allow customers of advertisement service 10 to perform sophisticated audience segmentation or advertisement impact studies across their own advertisements, as well as across the advertisements of other customers of advertisement service 10. As yet another example, analyzer 114 may be used for optimizing the geographic placement of new advertisement presentation nodes, for example in such a way that the new advertisement presentation nodes do not diminish revenues of existing advertisement presentation nodes. As yet another example, analyzer 114 may be used to replay and study the execution logs of previous advertisement presentations across multiple advertisement presentation nodes in the context of additional data sources, such as demographic, weather, or point of sales data. As yet another example, analyzer 114 may be able to provide reports on advertisements, advertisement presentation nodes, or geographic locations that are most highly rated by customers of advertisement service 10.

If included in advertisement service 10, billing component 116 provides functionality needed to bill customers of advertisement service 10, particularly if the billing data has to be dynamically determined, for example based on data coming from advertisement presentation nodes. In this case, billing component 116 may, for example, periodically determine the total individual debit of a customer based on successfully presented advertisements, apply specific billing rules such as discounts, bill the customer account accordingly, and trigger related payments to the owners or operators of involved advertisement presentation nodes. A number of billing models may be available to advertisement service 10 and supported by billing component 116, including, but not limited to, flat rates, periodic subscription fees, presentation location and time specific fees, advertisement content or presentation length specific fees, fees specific to the class of audience that an advertisement was presented to, or any combination thereof.

If included in advertisement service 10, connector 118 provides specific functionality allowing advertisement service 10 to interface with external components and services, such as external data mining, content design, or billing services.

Content service 130 may provide, for example, advertisement content design templates, digital video files, digital audio files, or advertisement texts to customers of advertisement service 10.

Location service 132 may provide, for example, geospatial data and services to advertisement service 10, such as street data, business location data, advertisement presentation node location data, audience-specific demographic data, or geocoding services.

Target audience recognition service 134 may allow advertisement service 10 to send digital images or videos of audiences or their vehicles to target audience recognition service 134 and receive classification data relating to these audiences. Advertisement service 10 may receive these digital images or videos from one or more advertisement presentation nodes. Additionally, or alternatively, advertisement presentation nodes may directly communicate with target audience recognition service 134 in order to use available target audience recognition services.

Data service 136 may, for example, provide demographic data, economic data such as a Consumer Price Index, weather data, customer data, credit score data, or traffic data to advertisement service 10. Additionally, or alternatively, advertisement service 10 may pass data to data service 136 in order to have it perform complex data analyses, such as profitability analyses of specific customers or advertisement presentation nodes.

A variety of other implementations of advertisement service 10 are within the scope of the present invention. For example, designer 104 and planner 106 may be merged or simulator 108 may be omitted. Furthermore, one or more components of advertisement service 10 may expose at least part of their functionality to other software applications in order to allow these software applications to integrate at least a part of the exposed functionality. This may be accomplished, for example, using web services. The term web service shall refer to any programmable application logic that is accessible using standard Internet protocols. For example, an external advertisement design application may integrate and use functionality exposed by distributor 110 of advertisement service 10 in order to have advertisement content distributed to one or more advertisement presentation nodes.

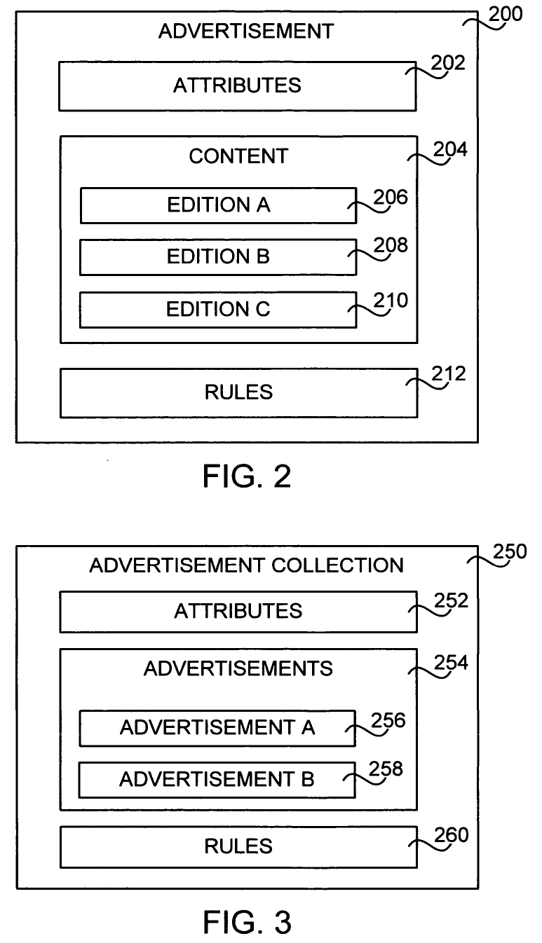

FIG. 2 depicts an example of an advertisement 200, which is a construct that contains attributes 202, content 204, and rules 212. The attributes 202 may contain, for example, a creation date, an advertisement identifier, a customer identifier, and a good-till-date. The advertisement identifier may be unique throughout the scope of advertisement service 10 and all connected advertisement presentation nodes. Content 204 may contain one or more editions 206, 208, and 210. The rules 212 may contain instructions, for example, suited to define which edition should be presented to which target audience. As another example, rules 212 may contain instructions suited to define that advertisement 200 shall only be presented if the local outside temperature is higher than 25 degree Celsius. As yet another example, rules 212 may contain instructions suited to define that advertisement 200 shall only be presented between 2 pm and 6 pm local time. As yet another example, rules 212 may contain instructions suited to define which billing process and pricing conditions shall be applied upon successfully presenting one of the editions 206, 208, and 210.

An advertisement can be understood as an instruction for an advertisement presentation node, the instruction containing data necessary to perform a presentation in the spirit of the present invention. An advertisement is typically at least partly defined by a customer of advertisement service 10. Data contained in an advertisement may be defined in the form of references, such as Uniform Resource Locators. From a business perspective, an advertisement can be understood as a contract between the advertisement service and an advertisement presentation node if the advertisement not only contains presentation-specific but also business-specific information, such as pricing or billing rules.

FIG. 3 depicts an example of an advertisement collection 250, which is a construct that contains attributes 252, advertisements 254 containing advertisement 256, and 258, and rules 260. Attributes 252 may contain, for example, a creation date, an advertisement collection identifier, a customer identifier, a budget, and a good-till-date. Rules 260 may contain instructions, for example, suited to define at which advertisement presentation nodes advertisement 256, and 258 are to be presented. Rules 260 may also contain conditions specifying under which circumstances specific advertisement presentation nodes shall or shall not present a specific advertisement contained in the advertisement collection. The circumstances may include, but are not limited to, competitive-, pricing-, environmental-, and budget-specific constraints.

An advertisement collection can be understood as a standardized instruction that allows a customer of advertisement service 10 to define under which conditions one or more advertisements are to be presented by which advertisement presentation nodes. Data contained in an advertisement collection may be defined in the form of references, such as Uniform Resource Locators.

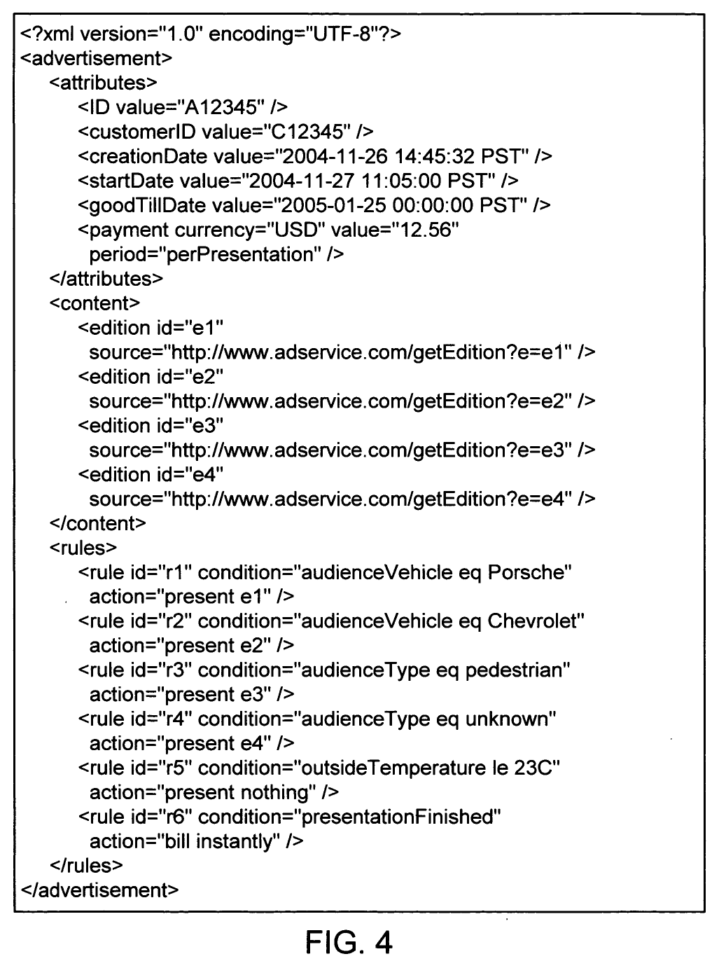

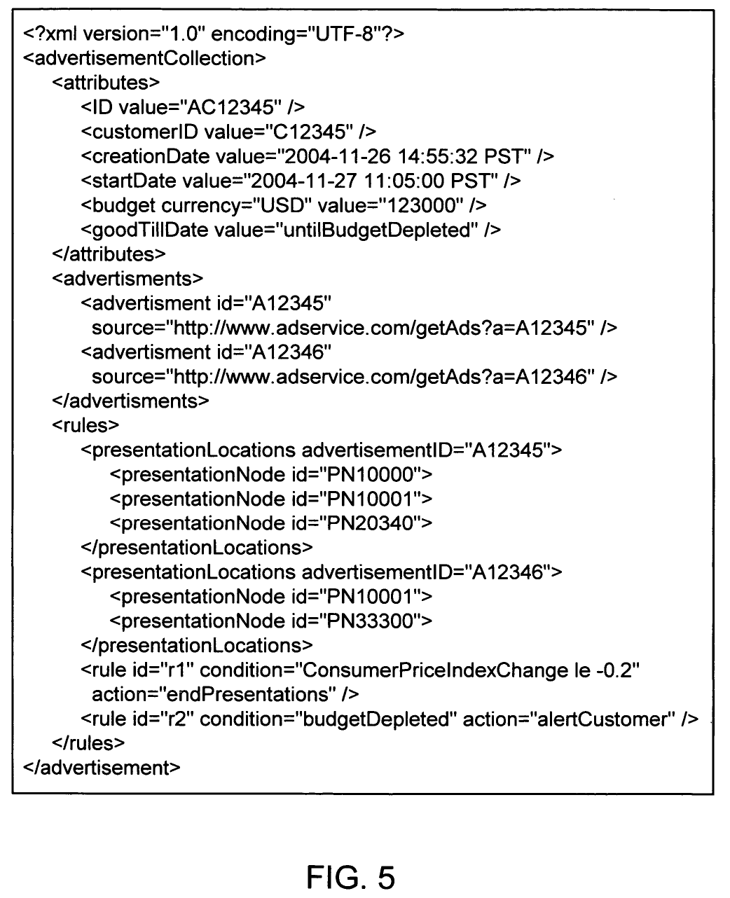

Advertisements and advertisement collections may, for example, be expressed using Extensible Markup Language (XML). FIG. 4 shows an example of an XML representation of an advertisement according to FIG. 2. FIG. 5 shows an example of an XML representation of an advertisement collection according to FIG. 3.

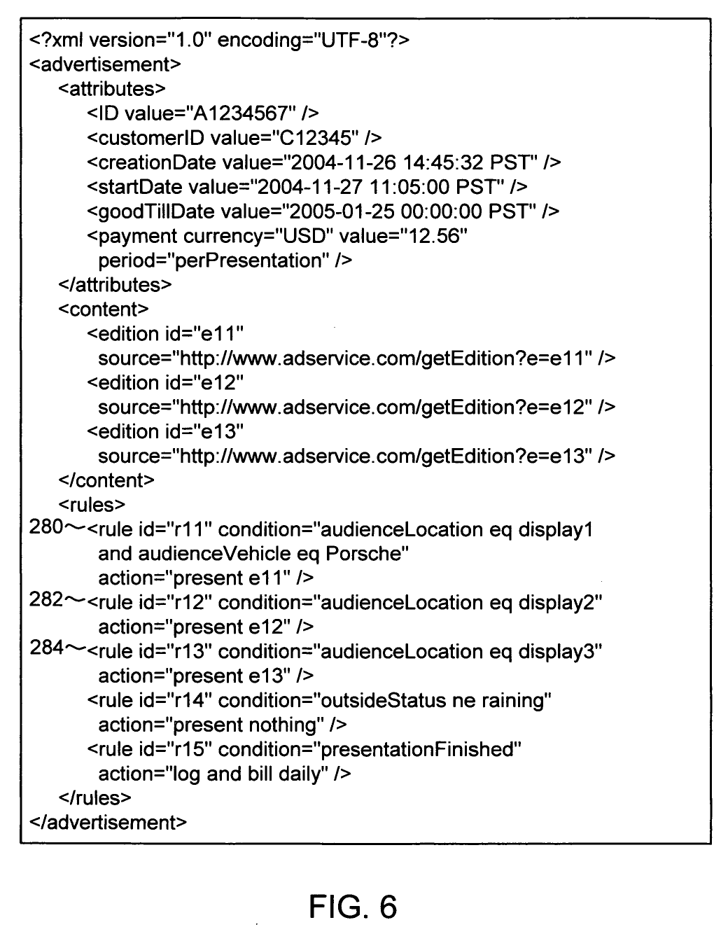

FIG. 6 is an example of an XML representation of an advertisement, the advertisement designed in such a way that it can be presented in various steps to audiences traveling along a specific route. In this case, the rules of the advertisement with the identifiers r11 280, r12 282, and r13 284 define which edition shall be presented depending on the current location of the audience. Here, it is assumed that the advertisement presentation node performing the presentation features at least three electronic displays that are placed in a specific distance from each other along the same route. As another example (not shown), the advertisement may contain a set of rules that would activate the presentation of a specific edition on a specific display only if a specific audience class were detected near that display. This would help ensuring that the specific audience class traveling along the route is presented the editions of the advertisement in a desired sequence.

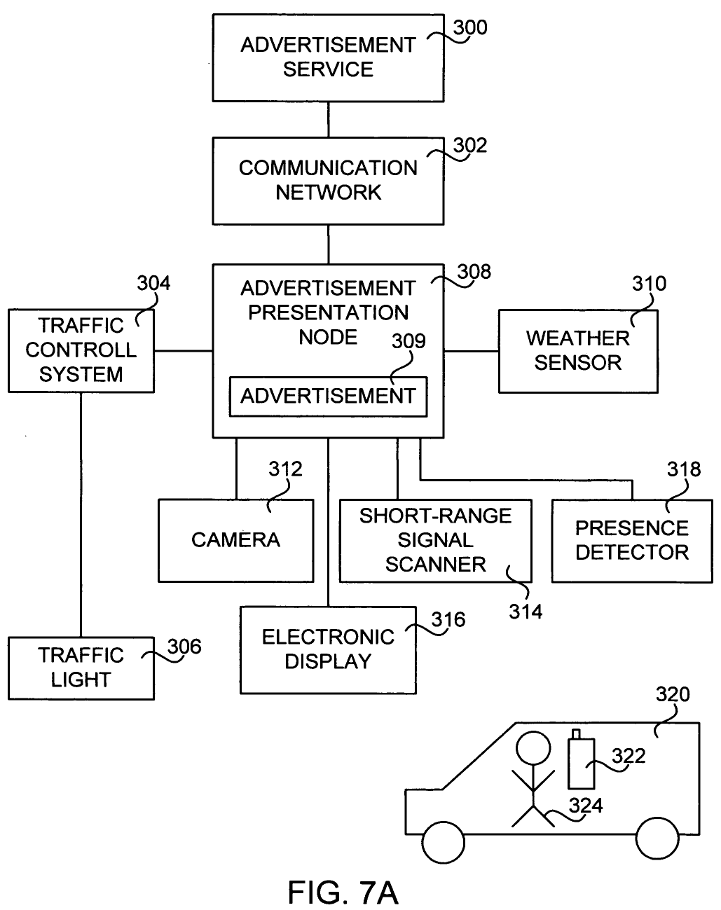

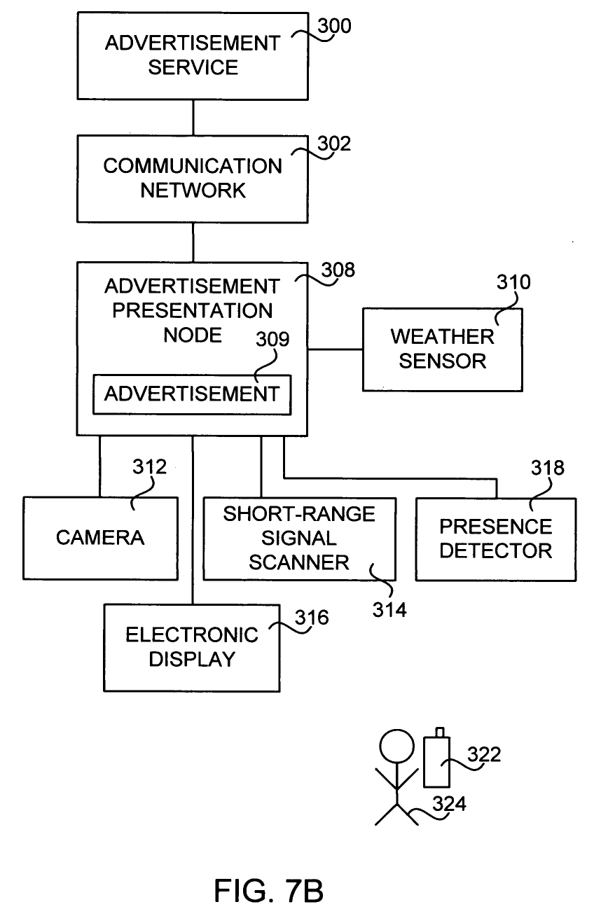

FIG. 7A depicts a typical implementation of the present invention. It shall be understood that all connections shown may be wired or wireless, asynchronous or synchronous in nature. An advertisement service 300 is connected to an advertisement presentation node 308 via a communication network 302. The advertisement presentation node 308 is connected to a traffic control system 304, a weather sensor 310, a camera 312, a short-range signal scanner 314, a presence detector 318, and an electronic display 316. The advertisement presentation node 308 has local access to an advertisement 309 that has been defined via advertisement service 300. Traffic control system 304 controls a traffic light 306. Traffic light 306 shows a red light. An audience 324 is waiting in front of the traffic light 306 inside of a vehicle 320. Audience 324 carries a cell phone 322, which is switched on.

Using its connection with traffic control system 304, or any other suitable means such as one or more sensors (not shown), advertisement presentation node 308 is able to detect that traffic light 306 is currently showing a red light. Using presence detector 318, or alternatively camera 312 and image recognition software, advertisement presentation node 308 is also able to detect that the vehicle 320 is currently waiting in front of traffic light 306. Presence detector 318 may, for example, be able to pick up the heat of the engine of vehicle 320 or may be able to detect metal located in front traffic light 306.

Upon detecting the presence of vehicle 320, advertisement presentation node 308 sends a digital image of vehicle 320 to advertisement service 300. Advertisement service 300 processes the digital image of vehicle 320 in such a way that the type or model of vehicle 320 is recognized and the resulting type or model information is sent back to advertisement presentation node 308. Alternatively, or additionally, advertisement presentation node 308 may be able to process the digital image of vehicle 320 and recognize the type or model of vehicle 320 locally without involving advertisement service 300. This may be accomplished, for example, by deploying data and software on advertisement presentation node 308 that allows relating an image of vehicle 320 to a vehicle type or model, for example by using image recognition software and a database containing vehicle-shape to vehicle-type or model relationships. Local recognition of encountered vehicle types may have a speed advantage, particularly if the available network bandwidth to external services is low.

Using one of the above-mentioned audience recognition methods, advertisement presentation node 308 determines that vehicle 320 is of type “Porsche”. Advertisement 309 contains three editions (not shown) and a rule (not shown) that defines which of the three editions is to be shown to which target audiences. The rule also specifies that any edition of advertisement 309 is only to be presented if the outside temperature is below 45 degree Fahrenheit. Using weather sensor 310, advertisement presentation node 308 determines that the outside temperature condition is fulfilled. Based on the aforementioned rule, advertisement presentation node 308 selects the edition targeted to audiences inside of vehicles of type “Porsche”, and starts presenting the selected edition via electronic display 316. If either the traffic light 306 is switched to green, or the presentation of the selected edition of advertisement 309 has reached its end, advertisement presentation node 308 stops the presentation of advertisement 309, and logs the available presentation context data, such as the presented edition, the total presentation time, and the detected vehicle type. Advertisement presentation node 308 reports the log data to advertisement service 300 and waits for the next opportunity to present advertisement 309 according to the above-mentioned process.

Using short-range signal scanner 314, advertisement presentation node 308 is also able to detect and interpret short-range communication signals transmitted by cell phone 322. Short-range signal scanner 314 may continually try to invoke and scan for, for example, Bluetooth signals in the area where vehicles that are waiting in front of traffic light 306 are typically located. If such signals are received, short-range signal scanner 314 may then try to receive data that allows identifying the types or models of the devices sending these signals. If cell phone 322 emits such a Bluetooth signal, advertisement presentation node 308 may be able to determine a typical market value of cell phone 322 which in turn may be used to validate or determine the classification of audience 324. This may be accomplished, for example, by using a specific web service via communication network 302 or by deploying data and software on advertisement presentation node 308 that allows retrieving a typical market value of detected devices based on their model description. Of course, as stated above, short-range signal scanner 314 may not be limited to using Bluetooth signals for the aforementioned identification of devices, but may additionally or alternatively support other suitable signal standards, methods or technologies to perform such identification.

Using short-range signal scanner 314, advertisement presentation node 308 is able to not only classify audiences in vehicles, but also audiences on bikes, audiences on motorbikes, or pedestrians, for example. In particular, advertisement presentation node 308 may control one or more additional or alternative electronic displays (not shown), for example visible to pedestrians waiting to cross a street controlled by traffic control system 304.

FIG. 7B depicts an alternative implementation of the present invention as an advertisement service may also either partly or even exclusively be connected with advertisement presentation nodes that are operated independently of traffic control systems, for example in locations featuring significant pedestrian traffic such as conference areas, waiting areas, or shopping malls. In this case, as depicted in FIG. 7B, advertisement presentation node 308 performs a presentation of advertisement 309 targeted to specific audience 324 applying at least a subset of the above-mentioned audience-class-recognition methods, however, excluding the recognition of the vehicle type an audience is traveling in. In this case, a classification of audience 324 may particularly be performed based on advanced face recognition methods that allow distinguishing gender-, age-, or other biometric attributes of audience 324, as well as the recognition of the type or model of device 322.

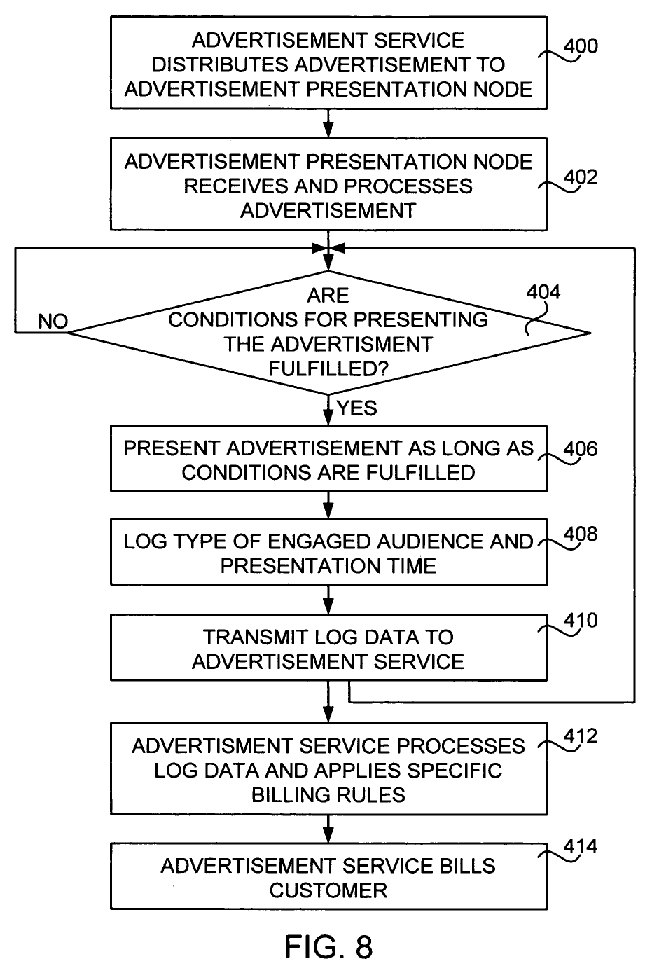

FIG. 8 is a flowchart illustrating an example of how an advertisement presentation node may interact with an advertisement service. In step 400, an advertisement service distributes an advertisement to an advertisement presentation node. In step 402, the advertisement presentation node receives and processes the advertisement. Processing the advertisement may particularly include downloading and caching its content, as well as updating a local presentation queue or schedule, for example in case other advertisements show overlapping or conflicting presentation requirements. In step 404, the advertisement presentation node determines whether all conditions for presenting the advertisement are fulfilled. This determination may include processing attributes or rules defined as part of the advertisement as well as checking external requirements such as the status of a relevant traffic light. If the requirements are not fulfilled, the advertisement presentation node continues with step 404. If the requirements are fulfilled, the advertisement presentation node continues with step 406 and performs the presentation of the advertisement as long as the requirements are fulfilled. Upon finishing the presentation, the advertisement presentation node logs the class of the audience engaged based on available data, as well as the elapsed presentation time. In step 410, the advertisement presentation node transmits the log data to the advertisement service, and continues with step 404. In step 412, the advertisement service processes the received log data and applies any specific billing rules. In step 414, the advertisement service bills the customer that placed the advertisement. The billing may be performed periodically, for example accumulating all presentation log data of one or more advertisement presentation nodes that have presented the advertisement during a specific amount of time.

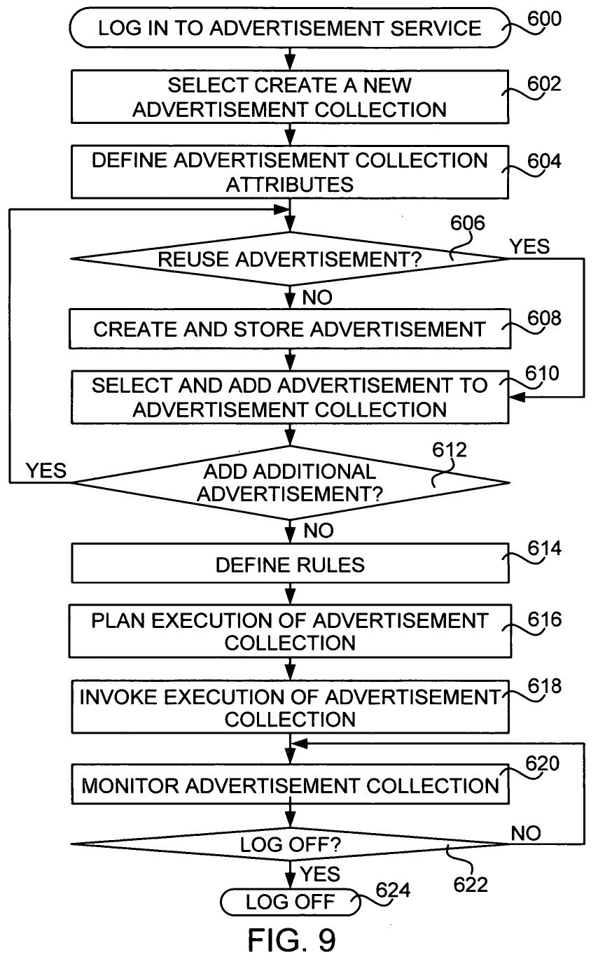

FIG. 9 is a flowchart illustrating an example of how a customer of an advertisement service may use the advertisement service. In step 600, a customer performs a log in to an advertisement service, for example via the Internet using a web browser. In step 602, upon successful authentication, the customer is presented with a user interface containing several options including functionality to create a new advertisement collection. The customer selects to create a new advertisement collection. In step 604, the customer defines attributes of the newly created advertisement collection, such as the desired start date of the advertisement collection, and a good-till-date. In step 606, the advertisement service presents the customer with an option to reuse an advertisement stored in the repository of the advertisement service for inclusion into the new advertisement collection. If the customer chooses not to reuse an advertisement, the advertisement service allows customer in step 608 to create a new advertisement, design or import the content of the advertisement, define the attributes and rules of the advertisement if applicable, and store the newly created advertisement in a repository of the advertisement service. If the customer either chooses to reuse an advertisement, or previously created and stored an advertisement, the advertisement service allows the customer to select and add this advertisement to the advertisement collection in step 610. In step 612, the customer is presented with an option to add another advertisement to the advertisement collection. If the customer chooses to add another advertisement, the advertisement service takes the customer to step 606. If the customer chooses not to add another advertisement to the advertisement collection, the advertisement service takes the customer to step 614. In step 614, the customer is asked to define and add any desired rules to the advertisement collection, such as specific billing periods or pricing limits.

In step 616, the customer is presented with functionality allowing the customer to plan the execution of the defined advertisement collection. In this step, the customer may be able to select one or more advertisement presentation nodes that shall conduct the presentation of the advertisement collection. The selection of advertisement presentation nodes may be accomplished by a number of different methods. For example, the customer may be able to input one or more specific addresses or cross streets. In this case, the advertisement service may return a list of advertisement presentation nodes at, or in the vicinity of, the selected locations, for selection by the customer.

Additionally or alternatively, the advertisement service may expose an interactive digital map that allows the customer to select one or more geographic areas or routes. In this case, the advertisement service may automatically select all advertisement presentation nodes within the selected areas or along the selected routes.

Additionally or alternatively, the advertisement service may expose a list of advertisement presentation nodes that can be ordered by the customer by attributes such as presentation costs, availability, presentation technology features, customer ratings, or average number of contacts with specific target audiences per week, for example. Selected advertisement presentation nodes may be included in the rules component of the advertisement collection as illustrated in FIG. 5.

Upon finishing the planning of the execution of the advertisement collection, the customer invokes the execution of the advertisement collection in step 618. In step 620, the customer monitors the execution of the advertisement collection. This may, for example, be accomplished by presenting the customer with a periodically refreshed digital map showing all advertisement presentation nodes that are actively involved in the execution of the advertisement collection. In this case, for example, each advertisement presentation node involved in the presentation may be represented by an icon depicting the number of total or recent target audience encounters.

In step 622, the customer is presented with an option to log off. If the customer chooses to log off, the customer is logged off in step 624. If the customer chooses not to log off, the customer is taken to, or remains at, step 620.

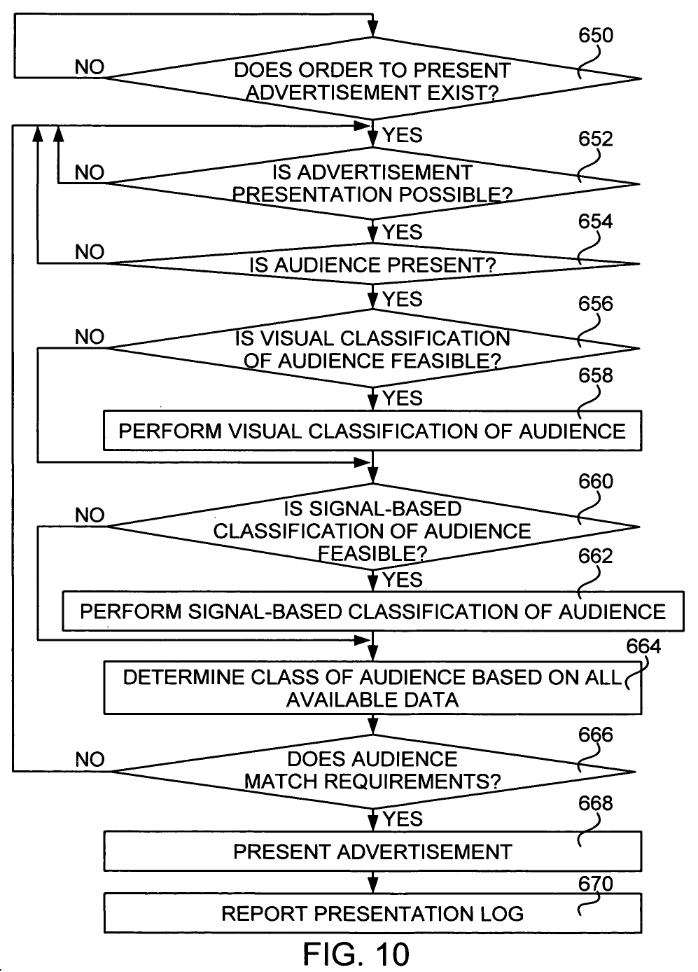

FIG. 10 is a flowchart illustrating an example of how an advertisement presentation node may detect, and react to, a specific class of audience. In step 650, the advertisement presentation node determines whether an order to present an advertisement exists. If no order exists, the advertisement presentation node repeats step 650. If an order exists, the advertisement presentation node continues with step 652 determining whether a presentation of the ordered advertisement is possible. In order to determine whether a presentation is possible, the advertisement presentation node may process and validate the rules contained in the ordered advertisement. For example, the presentation may not be possible if the current outside temperature is not within a defined range. If the presentation is not possible, the advertisement presentation node repeats step 652. If the presentation is possible, the advertisement presentation node continues with step 654 determining whether an audience is currently present. The presence of an audience may, for example, be detected by applying a presence detector or a camera and image recognition as described above. If no audience is detected, the advertisement presentation node continues with step 652. If an audience is detected, the advertisement presentation node continues with step 656 and determines whether a visual classification of the detected audience is feasible. A successful visual classification of the audience can be accomplished, for example, using hardware and software or external software services as described above, which allow, for example, to automatically recognize the type of vehicle the audience is using. If the necessary resources for a visual classification of the audience are available, the advertisement presentation node continues with step 658 and performs the visual classification of the audience. If either the visual classification of the detected audience is not feasible, or the visual classification was performed, the advertisement presentation node continues with step 660 and determines whether a signal-based classification of the audience is feasible. A successful signal-based classification of the audience can be accomplished, for example, using a short-range signal scanner as described above. If the necessary resources for a signal-based classification are available, the advertisement presentation node continues with step 662 and performs the signal-based classification of the audience. If either the signal-based classification of the audience is not feasible, or the signal-based classification was performed, the advertisement presentation node continues with step 666 and determines on the basis of all at this point available data whether the detected class of audience matches the requirements defined in the advertisement. If the requirements are not met, the advertisement presentation node continues with step 652. If the requirements are met, the advertisement presentation node continues with step 668 and presents the advertisement to the audience. Upon presenting the advertisement, the advertisement presentation node continues with step 670 and reports the presentation log to the advertisement service that initiated the presentation.

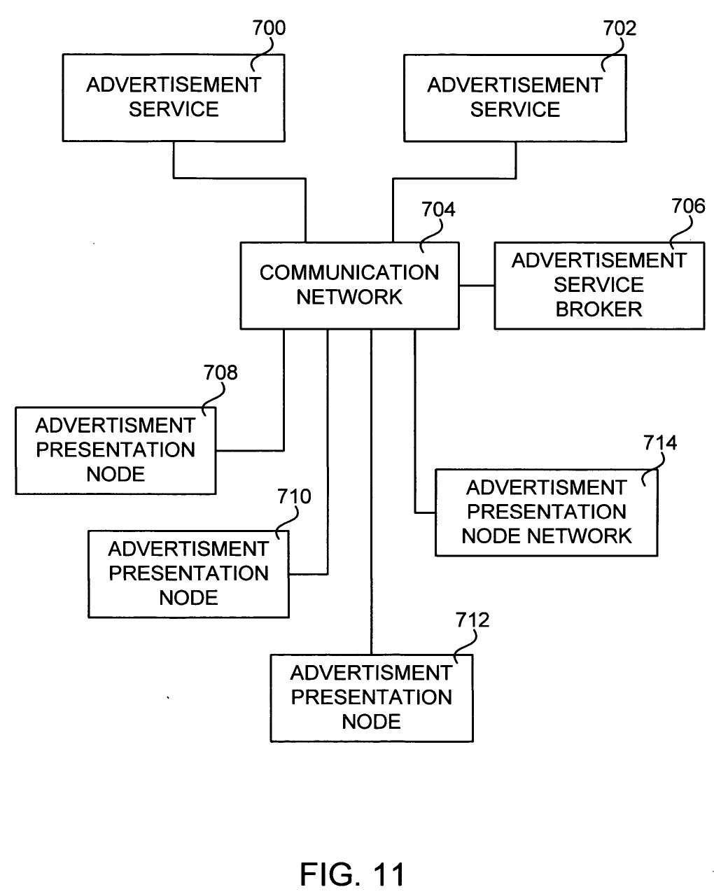

Looking at advertisement presentation nodes not as mere presentation devices that are remote-controlled by an advertisement service, but as independent “businesses” that offer presentation services, leads to a number of novel business methods or scenarios. FIG. 11 depicts an implementation supporting such a business method. Two advertisement services 700 and 702 are connected via communication network 704 to advertisement service broker 706, advertisement presentation nodes 708, 710, 712, and advertisement presentation node network 714. In this implementation, one or more of the connected advertisement presentation nodes may act like independent businesses that advertise their services to one or more advertisement services either directly or via one or more advertisement service brokers. In this case, for example, an advertisement presentation node may offer at least part of its available presentation time to the highest bidding advertisement service or advertisement service broker. This scenario is particularly relevant, for example, if there is a significant number of independently run advertisement presentation nodes that are not affiliated with, or part of, an advertisement service. A customer (not shown) seeking to run an advertisement on advertisement presentation nodes within a geographical region that is not covered by one single advertisement service, for example, could then order presentation time through an advertisement service broker on all available advertisement presentation nodes. In this example, the advertisement service broker may identify, and negotiate with, multiple advertisement presentation nodes or advertisement services on behalf of the customer, in order to gain the best possible coverage at the best possible price.

Advertisement services may support a number of advertisement strategies, scenarios, types, and customer segments. For example, business customers may rapidly place advertisements supporting local or large-scale sales or store events, advertise last minute vacancies, target specific audiences, and also automatically have their advertisements react to weather changes. Private customers may rapidly place birthday, wedding, or real estate sales information in their neighborhood or along a specific route. Public customers may place traffic, weather, or emergency information on specific locations or along specific routes.

Further implementations and benefits of the invention will be obvious to those skilled in the art.

### CONCLUSIONS

The inventions set forth above are subject to many modifications and changes without departing from the spirit, scope or essential characteristics thereof. Other embodiments of this invention will be obvious to those skilled in the art in view of the above disclosure. Thus, the embodiments explained above should be considered in all respect as being illustrative rather than restrictive of the scope of the inventions as defined in the appended claims.

What is claimed is:

1. A method for creating and presenting advertisements, comprising:
providing an advertisement service permitting the creation of one or more advertisements;
providing one or more advertisement display nodes able to communicate with said advertisement service;
creating an advertisement using said advertisement service;
enabling said one or more advertisement display nodes to present said advertisement to an audience.

2. The method of claim 1, wherein the method further comprises the acts of:
enabling at least one of said one or more advertisement display nodes to detect a status of a traffic light and selectively present said advertisement based at least in part on said status of said traffic light.

3. The method of claim 1, wherein the method further comprises the acts of:
enabling at least one of said one or more advertisement display nodes to distinguish between two or more classes of audiences.

4. The method of claim 1, wherein the method further comprises the acts of:
including one or more rules in said advertisement;
enabling at least one of said one or more advertisement display nodes to selectively present said advertisement based at least in part on said one or more rules included in said advertisement.

5. The method of claim 1, wherein the method further comprises the acts of:
enabling at least one of said one or more advertisement display nodes to receive a short-range signal transmitted by a device used by said audience;
enabling said at least one of said one or more advertisement display nodes enabled to receive said short-range signal to identify a class of said audience based at least in part on said received short-range signal.

6. The method of claim 1, wherein the method further comprises the acts of:
enabling at least one of said one or more advertisement display nodes to offer at least a part of its presentation time in a bidding process.

7. The method of claim 1, wherein the method further comprises the acts of:
enabling said advertisement service to provide an interactive visualization of a location and a status of at least one of said provided one or more advertisement display nodes.

8. The method of claim 1, wherein the method further comprises the acts of:
enabling said advertisement service to provide means for assisting a user of said advertisement service in identifying at least one of said one or more advertisement presentation nodes particularly well suited for presenting said advertisement according to a selected criteria.

9. The method of claim 1, wherein the method further comprises the acts of:
enabling at least one of said one or more advertisement presentation nodes to provide information to said advertisement service, said information comprising a result of a presentation of an advertisement performed by said at least one of said one or more advertisement presentation nodes.

10. The method of claim 1, wherein the method further comprises the acts of:
enabling said advertisement service to create one or more advertisement collections suited to express at least a part of an advertisement presentation strategy that can be executed by at least one of said one or more advertisement presentation nodes.

11. The method of claim 1, wherein the method further comprises the acts of:
providing one or more advertisement service brokers;
enabling said one or more advertisement service brokers to place one or more advertisements on one or more of said one or more advertisement presentation nodes for presentation according to criteria defined at least partly by a customer of said one or more advertisement service brokers.

12. A system for creating and distributing advertisements, comprising:
means permitting the creation of one or more advertisements;
means to distribute said one or more advertisements via one or more communication networks to one or more advertisement display nodes able to present said one or more advertisements to an audience.

13. The system of claim 12 comprising means for receiving data pertaining to one or more results of at least one presentation of said one or more advertisements.

14. The system of claim 13 wherein said system provides means to analyze said one or more results at least partly in order to bill one or more customers of said system based at least in part on said one or more results.

15. The system of claim 12 wherein said system provides means to include rules in said one or more advertisements, said rules suited to define one or more conditions that need to be fulfilled in order to present said one or more advertisements.

16. The system of claim 12 wherein said system provides means to visualize a status of at least one of said one or more advertisement display nodes.

17. The system of claim 12 comprising means for simulating at least one presentation of said one or more advertisements on said one or more advertisement display nodes.

18. The system of claim 12 wherein said system provides means to visualize a status of at least one of said one or more advertisement display nodes.

19. The system of claim 12 wherein said system permits creating one or more advertisement collections suited to express at least a part of an advertisement presentation strategy that can be executed by at least one of said one or more advertisement presentation nodes.

20. The system of claim 12 wherein said system provides means to use one or more advertisement service brokers for having said one or more advertisements presented.
